(19) United States
(12) Patent Application Publication
(10) Pub. No.: US 2010/0131276 A1
(43) Pub. Date: May 27, 2010

(54) AUDIO SIGNAL SYNTHESIS

(75) Inventors: Albertus Cornelis Den Brinker, Eindhoven (NL); Robert Johannes Sluijter, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,345

(22) PCT Filed: Jul. 6, 2006
(86) PCT No.: PCT/IB06/52291

§ 371 Date: Jan. 11, 2008

(30) Foreign Application Priority Data
Jul. 14, 2005 (EP) 05106437.6

(51) Int. Cl. G10L 13/00

(52) U.S. Cl. 704/262; 704/E15.001

(57) ABSTRACT

A device (2) for changing the pitch of an audio signal (r), such as a speech signal, comprises a sinusoidal analysis unit (21) for determining sinusoidal parameters of the audio signal (r), a parameter production unit (22) for predicting the phase of a sinusoidal component, and a sinusoidal synthesis unit (23) for synthesizing the parameters to produce a reconstructed signal (r′). The parameter production unit (22) receives, for each time segment of the audio signal, the phase of the previous time segment to predict the phase of the current time segment.

The present invention relates to audio signal synthesis. More in particular, the present invention relates to an audio signal synthesis device and method in which the phase of the synthesized signal is determined. The present invention further relates to a device and method for modifying the frequency of an audio signal, which device comprises the audio signal synthesis device or method mentioned above.

It is well known to synthesize audio signals using signal parameters, such as a frequency and a phase. The synthesis may be carried out to generate sound signals in an electronic musical instrument or other consumer device, such as a mobile (cellular) telephone. Alternatively, the synthesis may be carried out by a decoder to decode a previously encoded audio signal. An example of a method of encoding is parametric encoding, where an audio signal is decomposed, per time segment, into sinusoidal components, noise components and optional further components, which may each be represented by suitable parameters. In a suitable decoder, the parameters are used to substantially reconstruct the original audio signal.

The paper “Parametric Coding for High-Quality Audio” by A. C. den Brinker, E. G. P. Schuijers and A. W. J. Oomen, Audio Engineering Society Convention Paper 5554, Munich (Germany), May 2002, discloses the use of sinusoidal tracks in parametric coding. An audio signal is modeled using transient objects, sinusoidal objects and noise objects. The parameters of the sinusoidal objects are estimated per time frame. The frequencies estimated per frame are linked over frames, whereby sinusoidal tracks are formed. These tracks indicate which sinusoidal objects of a time frame continue into the next time frame.

International Patent Application WO 02/056298 (Philips) discloses the linking of signal components in parametric encoding. A linking unit generates linking information indicating components of consecutive extended signal segments which may be linked together to form a sinusoidal track.

Although these known methods provide satisfactory results, they have the disadvantage that the linking of sinusoids across time frame boundaries may introduce phase errors. If a sinusoid of a certain time frame is linked to the wrong sinusoid of the next time frame, a phase mismatch will typically result. This phase mismatch will produce an audible distortion of the synthesized audio signal.

It is therefore an object of the present invention to overcome these and other problems of the Prior Art and to provide a device and method of synthesizing audio signals in which phase discontinuities are avoided or at least are significantly reduced.

Accordingly, the present invention provides a signal synthesis device for synthesizing an audio signal, the device comprising:

a sinusoidal synthesis unit for synthesizing the audio signal using at least one frequency parameter representing a frequency of the audio signal and at least one phase parameter representing a phase of the audio signal, and

a parameter production unit for producing the (at least one) phase parameter using the (at least one) frequency parameter and the synthesized audio signal.

By producing the phase using the already synthesized audio signal, a phase loop is used which is capable of providing a substantially continuous phase. More in particular, the phase used in the sinusoidal synthesis unit is derived from the synthesized audio signal and can therefore be properly matched with the audio signal. As a result, the phase prediction is significantly improved and the number of phase prediction errors is thus drastically reduced. Any time delay involved in the loop is preferably taken into account.

In the device of the present invention, the conventional linking unit for linking signal components of consecutive segments may be deleted, thus avoiding any phase mismatches caused by such linking units.

In preferred embodiments, the synthesized audio signal comprises time segments, and the parameter production unit is arranged for producing the current phase parameter using a previous time segment of the audio signal. In these embodiments, the phase of a segment being synthesized is derived from the phase of a previously synthesized segment, preferably the immediately previous segment. In this way, a close relationship between the phase of the synthesized audio signal and the phase of the audio signal being synthesized is maintained.

It is further preferred that the parameter production unit comprises a phase determination unit arranged for determining a set of phase/frequency pairs, each phase/frequency pair representing the phase of a frequency of the audio signal. In this embodiment, a set of phases and their associated frequencies is derived from the synthesized audio signal.

Advantageously, the parameter production unit may further comprises a phase prediction unit arranged for:

comparing the frequency parameter with the set of phase/frequency pairs and selecting the phase/frequency pair nearest to the frequency parameter, and

producing the phase parameter using the frequency parameter and the selected phase.

Accordingly, the parameter production unit may select the frequency that best matches the frequency represented by the frequency parameter, and then use the phase associated with the selected frequency in the synthesis. This selection may be carried out several times, preferably once for each frequency, if multiple frequencies are used to synthesize the audio signal.

The synthesized audio signal may have the frequency (or frequencies) represented by the frequency parameter. However, it may also be desired to modify this frequency (or these frequencies). Accordingly, in an advantageous embodiment the parameter production unit comprises a frequency modification unit for modifying the frequency parameter in response to a control parameter. This (frequency) control parameter may, for example be a multiplication factor, a value of 1 corresponding with no frequency change, a value smaller than 1 corresponding with a decreased frequency and a value larger than 1 corresponding with an increased frequency. In other embodiments, the control parameter may indicate a frequency offset.

Although the present invention may be practiced using only a frequency parameter (or parameters) and a phase parameter (or parameters), it is preferred that additional parameters are used to further define the audio signal to be synthesized. Accordingly, the sinusoidal synthesis unit may additionally use an amplitude parameter. Additionally, or alternatively, the device of the present invention may further comprise a multiplication unit for multiplying the synthesized audio signal by a gain parameter.

If the synthesized audio signal is comprised of time segments (time frames), it is advantageous when the device further comprises an overlap-and-add unit for joining the time segments of the synthesized audio signal. Such an overlap-and-add unit, which may be known per se, is used to produce a substantially continuous audio data stream by adding partially overlapping time segments of the signal.

If a segmentation unit and an overlap-and-add unit are provided, the segmentation unit may advantageously be controlled by a first overlap parameter while the overlap-and-add unit is controlled by a second overlap parameter, the device being arranged for time scaling by varying the overlap parameters.

The device of the present invention may receive the frequency parameter, the phase parameter and any other parameters from a storage medium, a demultiplexer or any other suitable source. This will particularly be the case when the device of the present invention is used as a decoder for decoding (that is, synthesizing) audio signals which have previously been encoded using a parametric encoder. However, in further advantageous embodiments the device of the present invention may itself produce the parameters. In such embodiments, therefore, the device further comprising a sinusoidal analysis unit for receiving an input audio signal and producing a frequency parameter and a phase parameter.

Embodiments of the device in which the audio signal is first encoded (that is, analyzed and represented by signal parameters) and then decoded (that is, synthesized using said signal parameters) may be used for modifying signal properties, for example the frequency, by modifying the parameters.

Accordingly, the present invention also provides a frequency modification device comprising a signal synthesis device as defined above which includes a frequency modification unit for modifying the frequency parameter in response to a control parameter, and a sinusoidal analysis unit for receiving an input audio signal and producing a frequency parameter and a phase parameter.

The signal synthesis device of the present invention, when provided with a sinusoidal analysis unit for receiving an input audio signal and producing a frequency parameter and a phase parameter, may advantageously further comprise:

a further sinusoidal synthesis unit for producing a synthesized audio signal, and

a comparison unit for comparing the synthesized audio signal and the input audio signal so as to produce a gain parameter.

In this embodiment, a gain parameter is produced which allows the gain of the synthesized audio signal to be adjusted for any gain modifications due to the encoding (parameterization) process.

The device may further comprise a segmentation unit for dividing an audio signal into time segments. However, some embodiments may be arranged for receiving audio signals which are already divided into time segments and will not require a segmentation unit.

The present invention also provides a speech conversion device, comprising:

a linear prediction analysis unit for producing prediction parameters and a residual signal in response to an input speech signal,

a pitch adaptation unit for adapting the pitch of the residual signal so as to produce a pitch adapted residual signal, and

a linear prediction synthesis unit for synthesizing an output speech signal in response to the pitch adapted residual signal,

wherein the pitch adaptation unit comprises a device for modifying the frequency of an audio signal as defined above. The linear prediction synthesis unit may be arranged for synthesizing an output speech signal in response to both the pitch adapted residual signal and the prediction parameters.

The present invention additionally provides an audio system comprising a device as defined above. The audio system of the present invention may further comprise a speech synthesizer and/or a music synthesizer. The device of the present invention may be used in, for example, consumer devices such as mobile (cellular) telephones, MP3 or AAC players, electronic musical instruments, entertainment systems including audio (e.g. stereo or 5.1) and video (e.g. television sets) and other devices, such as computer apparatus. In particular, the present invention may be utilized in applications where bit and/or bit rate savings may be achieved by not encoding the phase of the audio signal.

The present invention also provides a method of synthesizing an audio signal, the method comprising the steps of:

synthesizing the audio signal using at least one frequency parameter representing a frequency of the audio signal and at least one phase parameter representing a phase of the audio signal, and

producing the phase parameter using the frequency parameter and the audio signal.

Preferably, the synthesized audio signal comprises time segments, and the phase production step comprises the sub-step of producing the current phase parameter using a previous time segment of the audio signal.

It is particularly preferred that the phase prediction step comprises the sub-step of determining a set of phase/frequency pairs, each phase/frequency pair representing the phase of a frequency of the audio signal.

The phase prediction step may further comprise the sub-steps of:

comparing the frequency parameter with the set of phase/frequency pairs and selecting the phase/frequency pair nearest to the frequency parameter, and

producing the phase parameter using the frequency parameter and the selected phase.

The phase prediction step may advantageously further comprise the sub-step of modifying the frequency parameter in response to a control parameter.

The present invention also provides a frequency modification method comprising a sinusoidal synthesis method as defined above which includes the sub-steps of modifying the frequency parameter in response to a control parameter, and receiving an input audio signal and producing a frequency parameter and a phase parameter.

The present invention further provides a speech conversion method, comprising the steps of:

producing prediction parameters and a residual signal in response to an input speech signal,

adapting the pitch of the residual signal so as to produce a pitch adapted residual signal, and

synthesizing an output speech signal in response to the pitch adapted residual signal,

wherein the pitch adaptation step comprise the frequency modification method as defined above.

The step of synthesizing an output speech signal may involve both the pitch adapted residual signal and the prediction parameters. Other advantageous method steps and/or sub-steps will become apparent from the description of the invention provided below.

The present invention additionally provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

The present invention will further be explained below with reference to exemplary embodiments illustrated in the accompanying drawings, in which:

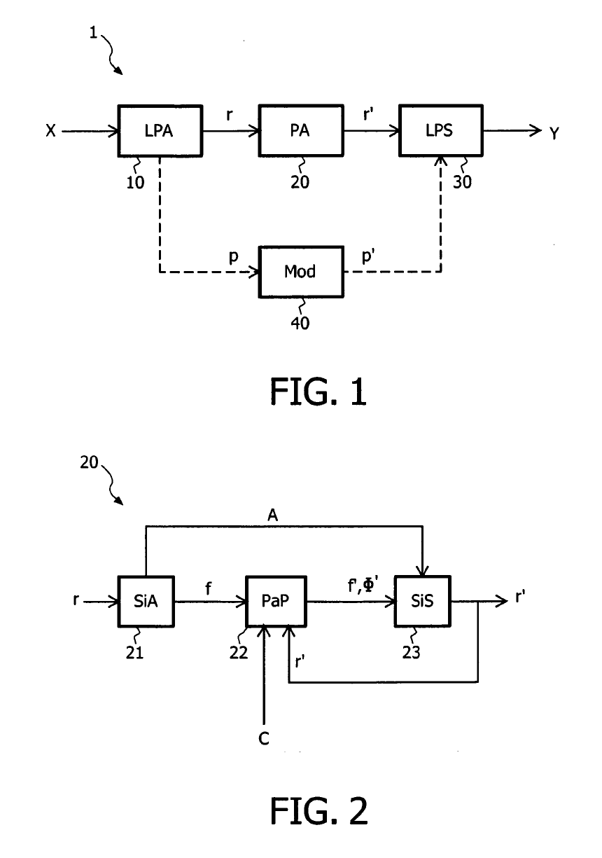

FIG. 1 schematically shows a parametric audio signal modification system according to the present invention.

FIG. 2 schematically shows an embodiment of an audio signal frequency modification device according to the present invention.

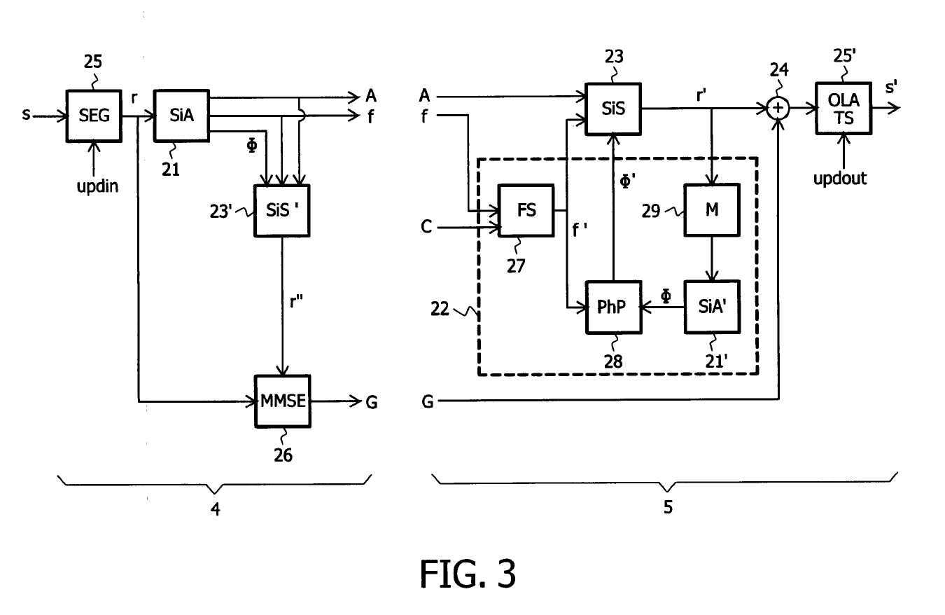

FIG. 3 schematically shows a frequency modifying audio signal encoder/decoder pair according to the present invention.

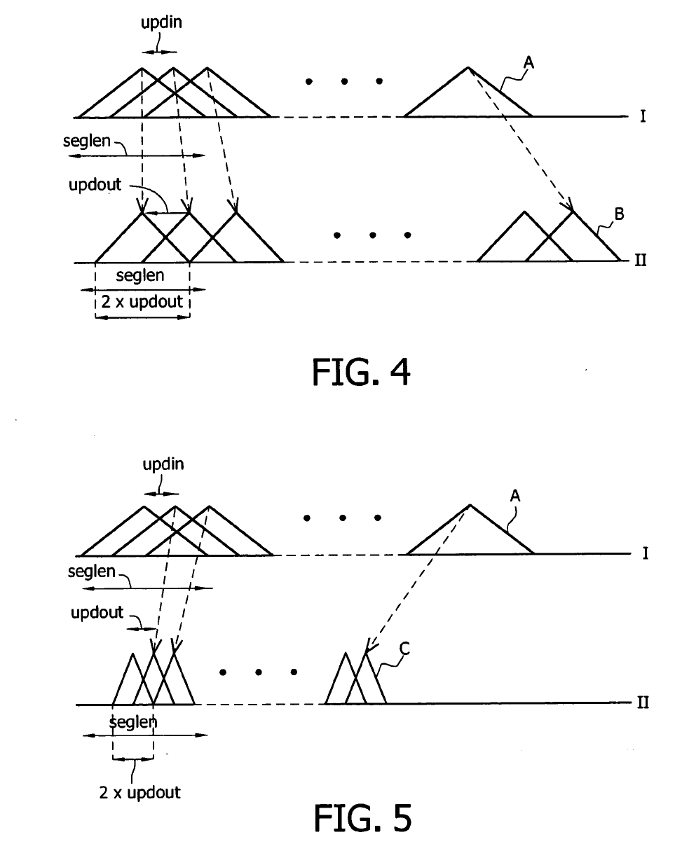

FIG. 4 schematically shows a first example of time scaling carried out by the audio signal encoder/decoder pair of FIG. 3.

FIG. 5 schematically shows a second example of time scaling carried out by the audio signal encoder/decoder pair of FIG. 3.

The parametric audio signal modification system 1 shown merely by way of non-limiting example in FIG. 1 comprises a linear prediction analysis (LPA) unit 10, a pitch adaptation (PA) unit 20, a linear prediction synthesis (LPS) unit 30 and a modification (Mod) unit 40. The structure of the parametric audio signal modification system 1 is known per se, however, in the system 1 illustrated in FIG. 1 the pitch adaptation unit 20 has a novel design which will later be explained in more detail with reference to FIGS. 2-4.

The system 1 of FIG. 1 receives an audio signal X, which may for example be a voice (speech) signal or a music signal, and outputs a modified audio signal Y. The signal X is input to the linear prediction analysis unit 10 which converts the signal into a sequence of (time-varying) prediction parameters p and a residual signal r. To this end, the linear prediction unit 10 comprises a suitable linear prediction analysis filter. The prediction parameters p produced by the unit 10 are filter parameters which allow a suitable filter, in the example shown a linear prediction synthesis filter contained in the linear prediction synthesis unit 30, to substantially reproduce the signal X in response to a suitable excitation signal. The residual signal r (or, after any pitch adaptation, the modified residual signal r′) serves here as the excitation signal. As indicated above, linear prediction analysis filters and linear prediction synthesis filters are well known to those skilled in the art and need no further explanation.

The pitch adaptation (PA) unit 20 allows the pitch (dominant frequency) of the audio signal X to be modified by modifying the residual signal r and producing a modified residual signal r′. Other parameters of the signal X may be modified using the further modification unit 40 which is arranged for modifying the prediction parameters p and producing modified prediction parameters p′. In the present invention, the further modification unit 40 is not essential and may be omitted. The prediction parameters p should, of course, be fed to the linear prediction synthesis unit 30 to allow the synthesis of the signal Y.

The device for modifying the frequency of an audio signal is schematically illustrated in FIG. 2. The device 20 may advantageously be used as pitch adaptation unit in the system of FIG. 1 but may also be used in other systems. It will therefore be understood that the device 20 may not only be applied in systems using linear prediction analysis and synthesis, but may also be used as an independent unit in audio signal modification devices and/or systems in which no linear prediction analysis and synthesis is used.

The device 20 shown in FIG. 2 comprises a sinusoidal analysis (SiA) unit 21, a parameter production (PaP) unit 22 and a sinusoidal synthesis (SiS) unit 23. It is noted that the sinusoidal analysis unit 21 and the sinusoidal synthesis unit 23 are different from the linear prediction analysis unit 10 and the linear prediction synthesis unit 30 of the system 1 illustrated in FIG. 1.

The sinusoidal analysis unit 21 receives an input audio signal r. This signal may be identical to the residual signal r of FIG. 1 but is not so limited. For example, the input audio signal r of FIG. 2 may be identical to the input audio signal X of FIG. 1 and may be a voice (speech) or music signal.

The sinusoidal analysis unit 21 analyses the input signal r and produces a set of signal parameters: a frequency parameter f and an amplitude parameter A. The frequency parameter f represents frequencies of sinusoidal components of the input signal r. In some embodiments multiple frequency parameters f₁, f₂, f₃, . . . may be produced, each frequency parameter representing a single frequency. The amplitude parameter A is not essential and may be omitted (for example when a fixed amplitude is used in the sinusoidal synthesis unit 23). However, in typical embodiments the amplitude parameter A (or multiple amplitude parameters A₁, A₂, A₃, . . . ) will be used. The sinusoidal analysis unit 21 is, in a preferred embodiment, arranged for performing a fast Fourier transform (FFT) to produce the frequency and amplitude parameters.

The parameter production unit 22 receives the frequency parameter(s) f from the sinusoidal analysis unit 21 and adjusts this parameter using a (frequency) control parameter C. The parameter production unit 22 may, for example, contain a multiplication unit for multiplying the frequency parameter f and the control parameter C to produce a modified frequency parameter f′, where f′=C·f. If, in this example, C is equal to 1 the frequency parameter is not modified, if C is smaller than 1 the value of the frequency parameter is decreased while if C is greater than 1 the value of the frequency parameter is decreased.

In accordance with the present invention the parameter production unit 22 also receives the synthesized signal r′ and derives the phase of this signal to produce a phase parameter φ′. The parameter production unit 22 feeds the modified frequency parameter f′ and the phase parameter φ′ to the sinusoidal synthesis unit 23, which also receives the (optional) amplitude parameter A. Using these parameters, the sinusoidal synthesis unit 23 synthesizes the output audio signal r′.

The sinusoidal synthesis unit 23 is, in a preferred embodiment, arranged for performing an inverse fast Fourier transform (IFFT) or a similar operation. The parameter production unit 22 will later be explained in more detail with reference to FIG. 3.

A frequency modifying audio signal encoder/decoder pair according to the present invention is schematically illustrated in FIG. 3. An encoder 4 and a decoder 5 are shown as separate devices, although these devices could be combined into a single device (20 in FIG. 2).

The audio signal encoder 4 illustrated merely by way of non-limiting example in FIG. 3 comprises a segmentation (SEG) unit 25, a sinusoidal analysis (SiA) unit 21, an (second) sinusoidal synthesis (SiS′) unit 23′, and a minimum mean square error (MMSE) unit 26. It is noted that the (additional) sinusoidal synthesis (SiS′) unit 23′ and the minimum mean square error (MMSE) unit 26 are not essential and may be deleted. It is further noted that the sinusoidal synthesis (SiS′) unit 23′ is denoted second sinusoidal synthesis unit to distinguish this unit from the (first) sinusoidal synthesis (SiS) unit 23 in the decoder 5.

The audio signal decoder 5 illustrated merely by way of non-limiting example in FIG. 3 comprises a sinusoidal analysis (SiS) unit 23, a parameter production unit 22, a gain control unit 24 and an overlap-and-add (OLA) and time scaling (TS) unit 25′. The parameter production unit 22, which substantially corresponds with the parameter production (PaP) unit 22 of FIG. 2, comprises a memory (M) unit 29, a (second) sinusoidal analysis (SiA′) unit 21′, a phase prediction unit 28, and an (optional) frequency scaling (FS) unit 27. It is noted that in some embodiments the frequency scaling (FS) unit 27 may be deleted. It is further noted that the sinusoidal analysis (SiA′) unit 21′ is denoted second sinusoidal analysis (SiA′) unit 21′ to distinguish this unit from the (first) sinusoidal analysis (SiA) unit 21 in the encoder 4.

The encoder 4 receives a (digital) audio signal s, which may be a voice (speech) signal, a music signal, or a combination thereof. This audio signal s is divided into partially overlapping time segments (frames) by the segmentation unit 25 to produce a segmented audio signal r. The segmentation unit 25 receives an (input) update interval parameter updin indicating the time spacing of the consecutive time segments. The segmented audio signal r may be equal to the signal r in FIGS. 1, 2 and 3, but is not so limited.

The sinusoidal analysis unit 21, which is preferably arranged for carrying out a fast Fourier transform (FFT), produces at least one frequency parameter f and, in the embodiment shown, also at least one amplitude parameter A and at least one phase parameter φ. The frequency parameter(s) f and the amplitude parameter(s) A are output by the encoder 4, while the phase parameter(s) φ is/are used internally. In the embodiment shown, the phase parameter φ is fed to the (additional) sinusoidal analysis unit 23′ where it is used, together with the parameters f and A, to synthesize the signal r″. Ideally, this synthesized signal r″ is substantially equal to the input audio signal r, apart from any gain discrepancy. To compensate this gain discrepancy, both the original (segmented) input audio signal r and the synthesized audio signal r″ are fed to a comparison unit, which in the embodiment shown is constituted by the minimum mean square error (MMSE) unit 26. This unit determines the minimum mean square error between the input audio signal r and the synthesized audio signal r″ and produces a corresponding gain signal G to compensate for any amplitude discrepancy. In some embodiments, this amplitude correction information may be contained in the amplitude parameter A or may be ignored, in which cases the units 23′ and 26 may be omitted from the encoder 4, while the gain control unit 24 may be omitted from the decoder 5.

It can thus be seen that the encoder 4 receives an input audio signal and converts this signal into a set of parameters f and A representing the signal, and an additional parameter G. The set of parameters is transmitted to the decoder 5 using any suitable means or method, for example via an audio system lead, an interne connection, a wireless (e.g. Bluetooth®) connection or a data carrier such as a CD, DVD, or memory stick. In other embodiments, the encoder 4 and the decoder 5 constitute a single device (20 in FIGS. 1, 2 and 3) and the connections between the encoder 4 and the decoder 5 are internal connections of said single device.

Accordingly, the decoder 5 receives the signal parameters f and A, and the additional parameters G and C. The amplitude A is fed directly to the sinusoidal synthesis unit 23, which preferably is arranged for performing an inverse fast Fourier transform (IFFT) so as to produce the synthesized signal r′=r′(n). The synthesis may be carried out using the formula:

$${r}^{′} ( n ) = {\sum }_{i = 0}^{k} {A}_{i} \cdot sin ( 2 π \cdot {f}_{i}^{′} \cdot n + {φ}_{i}^{′} ) ,$$

where k is the number of frequency components in the signal.

The parameters f and C are fed to the frequency scaling unit 27 of the parameter production unit 22, while the gain compensation parameter G is fed to the gain control (in the present embodiment: multiplication) unit 24.

The frequency scaling (FS) unit 27 uses the control parameter C to adjust (that is, scale) the frequency parameter f, for example by multiplying the control parameter C and the frequency parameter f. This results in an adjusted (that is, scaled) frequency parameter f′, which is fed to both the sinusoidal synthesis unit 23 and the phase prediction unit 28.

The sinusoidal synthesis unit 23 synthesizes an output audio signal r′ using the amplitude parameter A, frequency parameter f, and phase parameter φ′ (as mentioned above, the amplitude parameter A is not essential and may not be used in some embodiments). This synthesized signal r′ is fed to the gain control unit 24 which adjusts the amplitude of the signal r′ using the gain parameter G, and feeds the gain adjusted signal to the over-lap-and-add (OLA) and time scaling (TS) unit 25′. The OLA/TS unit 25′ also receives an (output) update interval parameter updout indicating the overlap of time segments of the output signal. Using the parameters updout, the signal values of the partially overlapping time segments are added to produce the output signal s′.

The synthesized signal r′ produced by the sinusoidal synthesis unit 23 is, in accordance with the present invention, fed to a memory (M) or delay unit 29 which temporarily stores the most recent time segment of the synthesized signal r′. This segment is then fed to the (second) sinusoidal analysis (SiA′) unit 21′ which determines the frequencies of the segment plus their associated phase values. That is, the sinusoidal analysis unit 21′ determines the frequency spectrum of the time segment, for example using an FFT, then determines the phase for all non-zero frequency values, and finally outputs a set of phase/frequency pairs, each pairs consisting of a frequency and its associated phase. The unit 21′ therefore produces a “grid” of (preferably only non-zero) frequency values, each (non-zero) frequency value having an associated phase value. In some embodiments a threshold value greater than zero may be used to eliminate small frequency values, as their associated phase values are often relatively inaccurate due to rounding errors.

The set of phase/frequency pairs produced by the unit 21′ is fed to the phase prediction unit 28, which compares the frequency parameter f′ with the frequencies of the set and selects the phase/frequency pairs that best match the frequencies represented by the parameter f′. The phase of the selected pair is then compensated for the time delay between the current segment and the previous segment by using the formula

φ′=φ+2π·f′·Δt,

where φ′ is the compensated phase parameter, φ is the phase of the selected phase/frequency pair, f′ is the (optionally modified) frequency parameter and Δt is the time delay. The resulting compensated phase parameter φ′ is then fed to the sinusoidal synthesis unit 23 to synthesize the next time segment of the signal r′.

It can thus be seen that the decoder of the present invention uses no linker, as in the Prior Art discussed above. The phase of the audio signal being synthesized is derived from the phase of the previously synthesized audio signal, in particular the audio signal of the last (that is, most recent) time segment.

It will be understood that if time segments are not used, other time delay criteria can be used in the phase prediction unit 28, for example criteria based upon processing time.

If the device 5 is used as a decoder without frequency adjustment, the frequency shift unit 27 may be omitted. If the encoder 4 and the decoder 5 are combined in a single device which includes the frequency shift unit 27, an advantageous frequency modification device results.

The encoder device 4 and the decoder device 5 illustrated in FIG. 3 may, individually or in combination, be used for time scaling. To this end, the update interval parameters updin and updout mentioned above may be suitably modified.

In FIG. 4, an input signal (for example the signal s in FIG. 3) is illustrated at time axis 1, while the corresponding output signal (for example the signal s′ in FIG. 3) is illustrated at time axis II. The signal is schematically represented in FIG. 4 by windows A and B, which are shown to be triangular for convenience but which may have any suitable shape, for example Gaussian or cosine-shaped. Each window captures a signal time segment having a length equal to the parameter seglen. During the segmenting process in the segmenting unit (25 in FIG. 3), the spacing of the windows A is determined by the parameter updin. Similarly, during the overlap-and-add process in the OLA unit (25′ in FIG. 3), the spacing of the windows B is determined by the parameter updout. By choosing updout greater than updin, as shown in FIG. 4, the signal s is expanded.

In FIG. 5, the situation is reversed in that the parameter updout is chosen smaller than updin, resulting in compression (that is, time compression) of the signal. It can thus be seen that by suitable modification of the parameters updin and updout, time scaling can be accomplished.

The present invention is based upon the insight that when synthesizing an audio signal, the phase of the signal to be synthesized may advantageously be derived from the audio signal that has been synthesized, that is, the recently (or preferably most recently) synthesized signal. This results in a phase having substantially no discontinuities. The present invention benefits from the further insights that the phase derived from the synthesized audio signal may be adjusted using the frequency of the signal to be synthesized, and that adjusting this frequency allows a convenient way of providing a frequency-adjusted signal.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A signal synthesis device (20) for synthesizing an audio signal (r′), the device comprising:
a sinusoidal synthesis unit (23) for synthesizing the audio signal (r′) using at least one frequency parameter (f′) representing a frequency of the audio signal and at least one phase parameter (φ′) representing a phase of the audio signal, and
a parameter production unit (22) for producing the phase parameter (φ′) using the frequency parameter (f) and the audio signal (r′).

2. The device according to claim 1, wherein the synthesized audio signal (r′) comprises time segments, and wherein the parameter production unit (22) is arranged for producing the current phase parameter (φ′) using a previous time segment of the audio signal (r′).

3. The device according to claim 1, wherein the parameter production unit (22) comprises a phase determination unit (21′) arranged for determining a set of phase/frequency pairs, each phase/frequency pair representing the phase of a frequency of the audio signal (r′).

4. The device according to claim 3, wherein the parameter production unit (22) further comprises a phase prediction unit (28) arranged for:
comparing the frequency parameter (f, f′) with the set of phase/frequency pairs and selecting the phase/frequency pair nearest to the frequency parameter (f′), and
producing the phase parameter (φ′) using the frequency parameter (f′) and the selected phase.

5. The device according to claim 1, wherein the parameter production unit (22) comprises a frequency modification unit (27) for modifying the frequency parameter (f) in response to a control parameter (C).

6. The device according to claim 1, wherein the sinusoidal synthesis unit (23) additionally uses an amplitude parameter (A).

7. The device according to claim 1, further comprising a gain control unit (24) for multiplying the synthesized audio signal (r′) by a gain parameter (G).

8. The device according to claim 1, further comprising a sinusoidal analysis unit (21) for receiving an input audio signal (r) and producing a frequency parameter (f′) and a phase parameter (φ′).

9. The device according to claim 8, further comprising:
a further sinusoidal synthesis unit (23′) for producing a synthesized audio signal, and
a comparison unit (26) for comparing the synthesized audio signal and the input audio signal so as to produce a gain parameter (G).

10. The device according to claim 2, further comprising a segmentation unit (25) for dividing the audio signal (r) into time segments.

11. The device according to claim 2, further comprising an overlap-and-add unit (25′) for joining the time segments of the synthesized audio signal (r′).

12. The device according to claims 10 and 11, wherein the segmentation unit (25) is controlled by a first overlap parameter (updin) and wherein the overlap-and-add unit (25′) is controlled by a second overlap parameter (updout), and wherein the device is arranged for time scaling by varying the overlap parameters (updin, updout).

13. A speech conversion device (1), comprising:
a linear prediction analysis unit (10) for producing prediction parameters (p) and a residual signal (r) in response to an input speech signal (x),
a pitch adaptation unit (20) for adapting the pitch of the residual signal (r) so as to produce a pitch adapted residual signal (r′), and
a linear prediction synthesis unit (30) for synthesizing an output speech signal (y) in response to the pitch adapted residual signal (r′),
wherein the pitch adaptation unit (20) comprises a device according to claim 5.

14. The speech conversion device according to claim 13, further comprising a modification unit (40) for modifying the prediction parameters.

15. An audio system, comprising a device according to claim 1.

16. An audio signal decoder (5), comprising:
a sinusoidal synthesis unit (23) for synthesizing the audio signal (r′) using at least one frequency parameter (f′) representing a frequency of the audio signal and at least one phase parameter (φ′) representing a phase of the audio signal, and
a parameter production unit (22) for producing the phase parameter (φ′) using the frequency parameter (f) and the audio signal (r′).

17. A method of synthesizing an audio signal (r′), the method comprising the steps of:
synthesizing the audio signal (r′) using at least one frequency parameter (f, f′) representing a frequency of the audio signal and at least one phase parameter (φ′) representing a phase of the audio signal, and
producing the phase parameter (φ′) using the frequency parameter (f, f′) and the audio signal (r′).

18. The method according to claim 17, wherein the synthesized audio signal (r′) comprises time segments, and wherein the parameter production unit (22) is arranged for producing the current phase parameter (φ′) using a previous time segment of the audio signal (r′).

19. The method according to claim 17, wherein the phase prediction step comprises the sub-steps of determining a set of phase/frequency pairs, each phase/frequency pair representing the phase of a frequency of the audio signal (r′).

20. The method according to claim 17, wherein the phase prediction step further comprises the sub-steps of
comparing the frequency parameter (f′) with the set of phase/frequency pairs and selecting the phase/frequency pair nearest to the frequency parameter (f′), and
producing the phase parameter (φ′) using the frequency parameter (f′) and the selected phase.

21. The method according to claim 17, wherein the phase prediction step comprises the sub-step of modifying the frequency parameter (f′) in response to a control parameter (C).

22. A speech conversion method, comprising the steps of:
producing prediction parameters (p) and a residual signal (r) in response to an input speech signal (x),
adapting the pitch of the residual signal (r) so as to produce a pitch adapted residual signal (r′), and
synthesizing an output speech signal (y) in response to the pitch adapted residual signal (r′),
wherein the pitch adaptation step comprises a sub-step of changing the frequency of an audio signal according to claim 21.

23. A method according to claim 17 or 22, further comprising the step of time scaling.

24. A computer program product for carrying out the method according to claim 17 or 22.
